(19) United States
(12) Patent Application Publication
(10) Pub. No.: US 2026/0163826 A1
(43) Pub. Date: Jun. 11, 2026

(54) DETECTION AND CLASSIFICATION OF MEDIA FLOWS IN VIDEO CONFERENCING SOFTWARE

(71) Applicant: Cisco Technology, Inc., San Jose, CA (US)

(72) Inventors: Julien Armand Pierre Gamba, Madrid (ES); Kyle Graham Schomp, Avon, OH (US); Ricardo Santos Morla, Vila Nova de Gaia (PT); Arash Molavi Kakhki, San Francisco, CA (US); André Felipe Zanella, Barcelona (ES)

(73) Assignee: Cisco Technology, Inc., San Jose, CA (US)

(21) Appl. No.: 19/200,016

(22) Filed: May 6, 2025

Related U.S. Application Data
(60) Provisional application No. 63/729,612, filed on Dec. 9, 2024.

(51) Int. Cl. H04L 43/026; H04L 43/08; H04N 7/15

(52) U.S. Cl. CPC H04L 43/026; H04L 43/08; H04N 7/15

(57) ABSTRACT

In one implementation, a device obtains telemetry data for network traffic associated with a videoconference call. The device computes, based on the telemetry data, flow metrics for the network traffic comprising one or more of: a packet size metric or an interframe time metric. The device classifies the network traffic as being of a particular media type based on the flow metrics. The device provides an indication that the network traffic is of the particular media type.

### RELATED APPLICATION

The present disclosure claims priority to U.S. Prov. Appl. Ser. No. 63/729,612, filed on Dec. 9, 2024, entitled DETECTION AND CLASSIFICATION OF MEDIA FLOWS IN VIDEO CONFERENCING SOFTWARE, by Gamba, et al., the contents of which are incorporated herein by reference.

### TECHNICAL FIELD

The present disclosure relates generally to computer networks and more particularly to the detection and classification of media flows in video conferencing software.

### BACKGROUND

With the rise of popularity of remote work, ensuring a sufficient level of Quality of Experience (QoE) in collaborative applications has become of the utmost importance for enterprises. In particular, network monitoring of video conferencing software is now essential to ensure employees can work reliably outside of the office. While identifying all flows from a given video conferencing application is straight forward, not all are worth monitoring. Indeed, these services often rely on a number of connections for different purposes, but not all directly affect call quality.

However, detecting crucial flows for QoE such as media flows remains challenging. More specifically, applications and standards are moving towards more encryption on application-level headers like Real-Time-Protocol (RTP), the default protocol for sending video and audio over Internet Protocol (IP) networks. While this adds an extra layer of security for users, it also imposes additional complications for detecting media flows and calculating QoE metrics. Native applications (i.e., those not accessed through a web browser) typically select server-side IP addresses at runtime, which makes tracking relevant flows cumbersome as one cannot rely on a static list of IP addresses to monitor. Beyond the detection of such flows, it is also challenging to determine the QoE for such flows.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIGS. 4A-4B illustrate example plots demonstrating that the User Datagram Protocol (UDP) is not used exclusively for media flows;

FIG. 5 illustrates an example plot of media traffic being sent directly from one peer to another;

FIG. 6 illustrates an example plot of a call participant uploading a file during a call;

FIG. 7 illustrates an example of media flow traffic during a Microsoft Teams calls;

FIG. 8 illustrates an example lab testbed setup;

FIG. 9 illustrates an example of the packet sizes of different types of packets;

FIGS. 10A-10D illustrate plots of the distribution of packet sizes by media types for calls with different numbers of participants;

FIGS. 11A-11B illustrate plots of the arrival rates and inter-frame times of test calls;

FIGS. 12A-12D illustrate plots comparing frame rate detection approaches;

FIGS. 13A-13B illustrate plots of the distribution of passively estimated interframe times;

FIGS. 14A-14D illustrate measurement plots for test calls with screen sharing;

FIGS. 15A-15C illustrate plots demonstrating the passive estimation of the frame rate;

FIGS. 16A-16C illustrate plots demonstrating the passive measurements of network degradation conditions;

FIGS. 17A-17B illustrate plots showing the packet arrival rate dynamics for calls with three participants; and

FIG. 18 illustrates an example procedure for the detection and classification of media flows in video conferencing software.

### DESCRIPTION OF EXAMPLE IMPLEMENTATIONS Overview

According to one or more implementations of the disclosure, a device obtains telemetry data for network traffic associated with a videoconference call. The device computes, based on the telemetry data, flow metrics for the network traffic comprising one or more of: a packet size metric or an interframe time metric. The device classifies the network traffic as being of a particular media type based on the flow metrics. The device provides an indication that the network traffic is of the particular media type.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

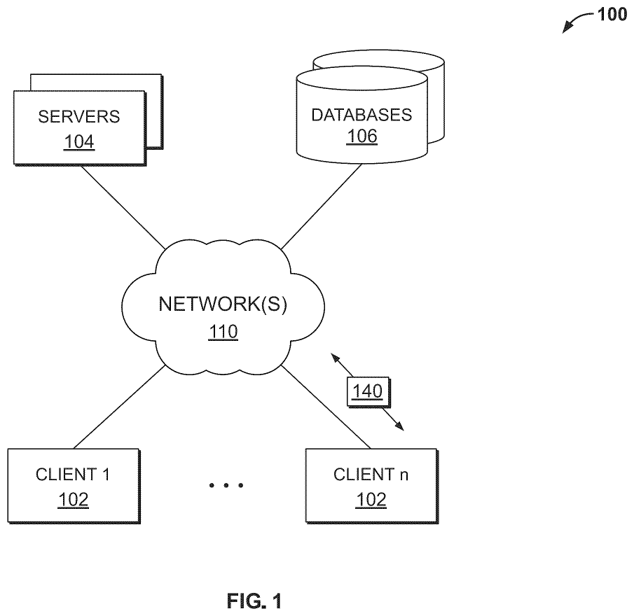

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

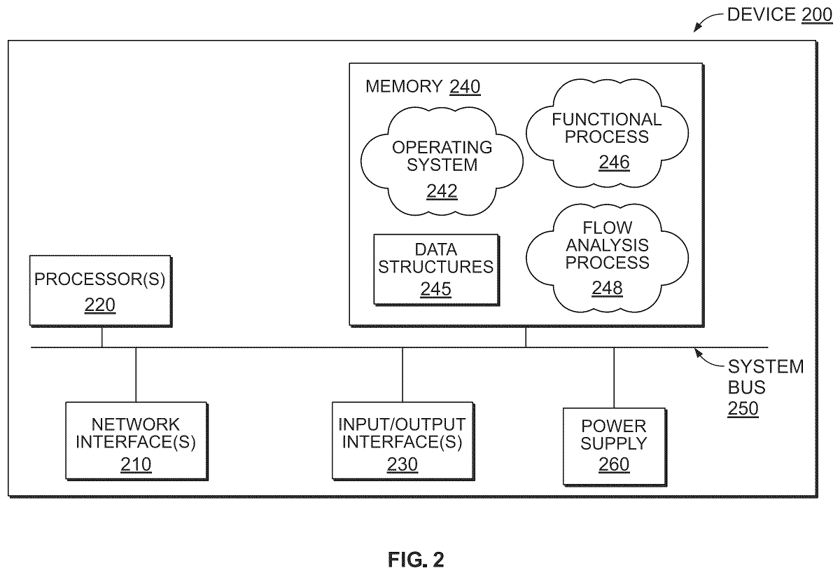

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as flow analysis process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, flow analysis process 248 may include computer executable instructions that, when executed by processor 220, cause device 200 to perform the techniques described herein. To do so, in some implementations, flow analysis process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, Mis a statistical model, and the cost function is inversely proportional to the likelihood of M, given the input data.

In various implementations, flow analysis process 248 may employ and/or be utilized to handle prompts to and/or access of one or more supervised, unsupervised, or semi-supervised machine learning models trained to perform usage drop detection, generate pseudo measurement generation, perform root cause analysis, etc.

Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that flow analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, flow analysis process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), foundation models such as large language models (LLMs), other transformer models, and the like.

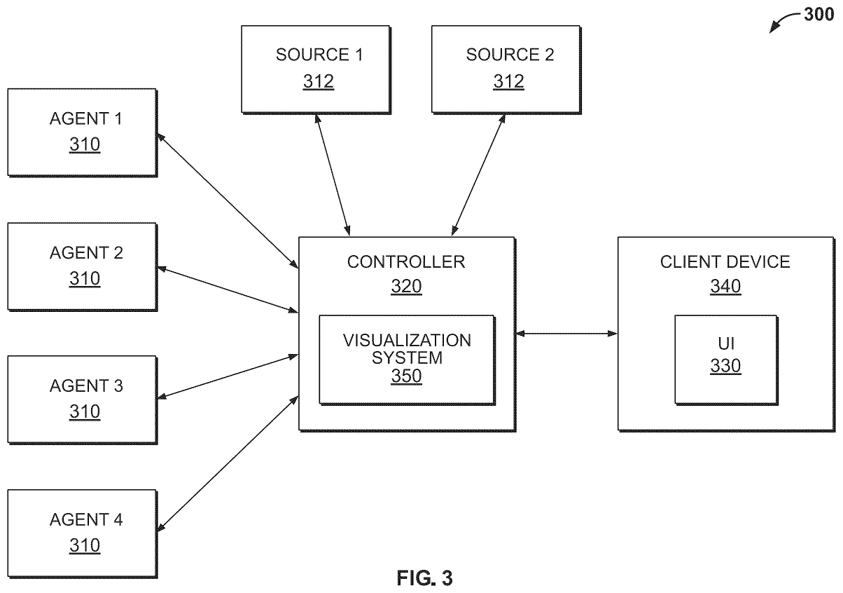

FIG. 3 is a block diagram of an example of an observability intelligence platform 300 that can implement one or more aspects of the techniques herein. The observability intelligence platform 300 is a system that monitors and collects metrics of performance data for a network and/or application environment being monitored. At the simplest structure, the observability intelligence platform 300 includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform 300. The controller 320 may serve a user interface 330 (denoted UI in FIG. 3), such as a browser-based UI, that is the primary interface for monitoring, analyzing, and troubleshooting the monitored environment. S_{P} ecifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, detecting and classifying media flows in video conferencing software is important to be able to infer quality of experience (QoE) metrics from such flows. However, monitoring the application traffic of native video conferencing applications can prove challenging. Indeed, such applications may contact many servers while running, but the actual destination is typically decided at runtime. This makes it hard, if not impossible, to determine an exhaustive list of IP addresses or domain names to monitor. Moreover, not all of these connections are worth monitoring: while some are indeed essential to the smooth running of the application, some are less important from a user perspective. This is especially true of video conferencing applications where users want video calls to have as little delay as possible, while chat messages can be delayed without prejudice for the user.

Indeed, with the increasing popularity of remote work, ensuring a sufficient level of Quality of Experience (QoE) in collaborative applications has become critical for enterprises. In particular, network monitoring of video conferencing is essential to ensure that employees can work reliably from anywhere. The monitoring of video conferencing has received much attention and involves solving several problems. First, because video conferencing applications typically generate a variety of network flows, the critical media flows must be isolated from all of the other traffic. Second, this identification should ideally be performed at run-time because the applications often select the server IP addresses dynamically and use the same server IP addresses for both media flows and control flows. Third, standards and applications are moving towards more encryption, making it harder to identify media flows and extract application-layer metrics.

### Detection and Classification of Media Flows in Video Conferencing Software

According to one or more implementations of the disclosure, the techniques herein provide for media flow detection and classification in video conferencing applications. In some aspects, the detection approach relies on counting inbound and outbound packets in discrete windows of two seconds of traffic. For instance, any flow with at least ten packets per window for ten consecutive windows may be deemed a media flow. Further aspects of the techniques herein relate to assessing metrics such as the average packet size, throughput, average interframe timing, etc., to classify the media flows into audio, video, and screensharing, for efficient and near real-time identification and classification of media flows from video conferencing applications, for both native and WebRTC-based applications.

In various implementations, the techniques herein leverage insights drawn from traffic patterns and only needs network and transport layer metadata, without depending upon payload that could be encrypted. This allows the techniques herein to detect media flows accurately in seconds, without prior knowledge of the application's internals. These techniques have also been verified using both a lab setup for Microsoft Teams, Zoom, Cisco Webex, and Google Meet, and at scale in a real-world environment for Microsoft Teams. Further aspects of the techniques herein relate to the extraction of application-layer metrics to allow for the estimation of the QoE of media flows by using only Layer-4 packet metadata (i.e., not using any packet payload), and demonstrate that heuristic-based estimations perform well under network degradation for Microsoft Teams.

Illustratively, the techniques described herein may be performed by hardware, software, and/or firmware, such as in accordance with flow analysis process 248, which may include computer executable instructions executed by the processor 220 (or independent processor of interfaces 210) to perform functions relating to the techniques described herein.

Operationally, before delving into the techniques herein, it should be appreciated that video conferencing applications allow for real-time communication between two or more users. Depending on the number of participants on a call, these applications can work either in peer-to-peer fashion or using a relay. When using peer-to-peer, the application must be able to perform Network Address Translation (NAT) traversal and establish the connection between the participants, typically using the STUN or TURN protocols. This is because most networks, both residential and ISP networks, implement some flavor of NAT to cope with the shortage of public IP(v4) addresses. Because there can be multiple machines behind the same public IP address, an application that wishes to establish a direct connection with another host must first traverse the NAT.

Using a relay instead allows for more participants to join the call, since the relay can perform the task of distributing media to all participants. In practice, there can be more than one relay for a given call. Redistributing media across participants opens the door to potential performance downgrades, depending upon the location of both the call participants and the relays, hence why applications first try to establish a direct connection in the case of two-participant calls.

The majority of video conferencing applications rely on RTP and the RTP Control Protocol (RTCP) to send media traffic, although some applications may choose to use other protocols or to encapsulate RTP into a proprietary protocol. RTP and RTCP provides a framework that allow applications to deliver media traffic in a real-time fashion. These two protocols provide useful features to application developers that are not limited to the transport of media traffic (e.g., loss detection and correction, payload type identification, or membership management). RTCP is used alongside RTP. The application will periodically send RTCP reports which are then used by other participants of the call to synchronize the different media flows together, or to provide feedback about the quality of the received media. Among others, it is possible to use RTCP reports to know how many packets were lost during the call or to compute the packet jitter along the network path.

By default, the majority of these applications rely on UDP as a transport protocol, and support using TCP as a fallback if UDP is not available (e.g., policy blocked). It is common for videoconferencing applications to also offer web variants that run in a web browser. These rely on the WebRTC standard for video calls.

Applications can integrate RTP and RTCP directly, and web-based applications can rely on WebRTC. WebRTC provides a set of standard APIs that is implemented by the major web browsers (Chrome, Edge, Firefox, and Safari). Using WebRTC, a web-app can establish a direct connection to another host and allow audio or video communication. WebRTC can either rely on RTP to transport the media traffic, but it is also possible to use another protocol instead.

According to various implementations, flow analysis process 248 may be configured to detect media flows during a call in a videoconferencing application such as Microsoft Teams, Webex, Zoom, or the like. In addition, flow analysis process 248 may be configured to then classify the media flows based on their contents (e.g., audio, video, screensharing, etc.).

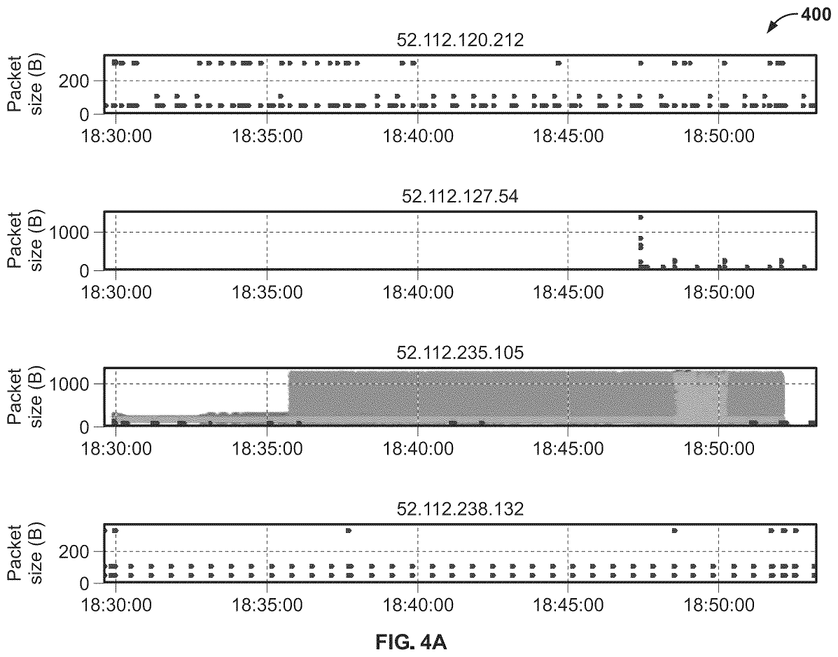

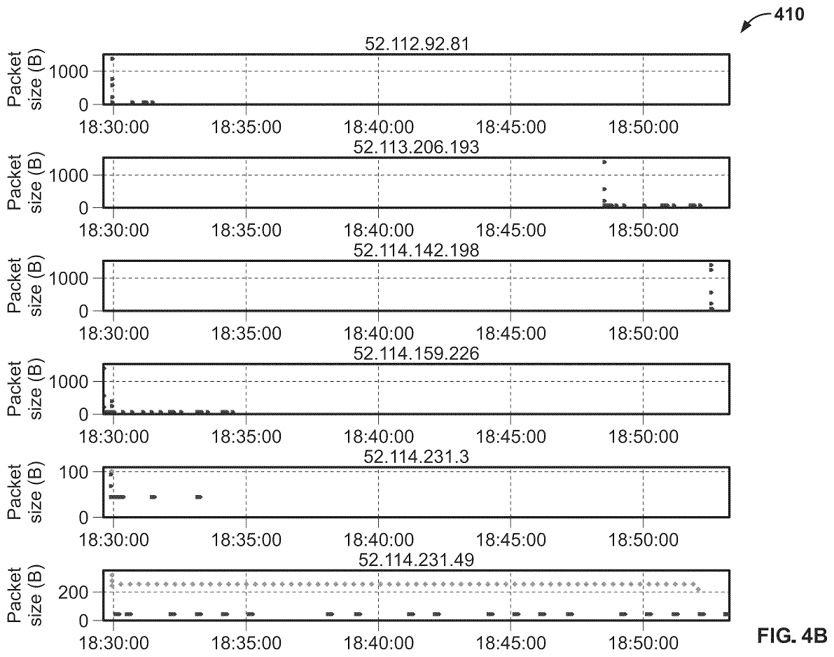

Before delving into the techniques herein, the anatomy of a typical call in a videoconferencing should be understood. For instance, FIGS. 4A-4B illustrate example plots of the different IP addresses contacted by Microsoft Teams during a call with outbound traffic only. For each IP address the packets' sizes over time. Most of the servers that are contacted do not receive much traffic, either small bursts of packets isolated in time, or small packets sent at regular intervals.

In this scenario, servers used for media traffic stand out: IP address 52.112.235.105 receives significantly more traffic. It should be noted that in this particular test, there is only one server used for media traffic. However, other tests have demonstrated that multiple servers may also be used during one call including different servers used for audio/video at the same time, and different servers used for the same purpose but at different times).

From FIGS. 4A-4B, it can also be seen that UDP is not used exclusively for media streams. Indeed, there are bursts of UDP traffic that do not correspond to media traffic. This means that one cannot simply consider all UDP streams media streams and must look at the traffic patterns instead.

Webex and Zoom produce similar traffic patterns: large amounts of traffic towards one or two destinations (albeit on different ports than for MS Teams) and small bursts of traffic towards several others. As for Microsoft Teams, one cannot rely only on the protocol used to determine which servers are responsible for media traffic.

In various implementations, flow analysis process 248 may assess network traffic flows on a per-flow basis to detect media servers (regardless of the nature of the media, audio, video, or screen share). For each flow (identified by a tuple IP, port, and protocol), flow analysis process 248 may then discretize the data into time windows (e.g., windows of two seconds each or some other suitable timespan). Flow analysis process 248 may then assess the number of outbound or inbound packets per window to distinguish between servers used for media traffic and servers used for other kinds of traffic. If a given server receives at least a threshold number of packets inbound or threshold number of packets outbound per window during n-number consecutive windows, flow analysis process 248 may consider that this server is used for media traffic. For instance, thresholds of ten inbound or ten outbound packets during ten consecutive windows has been validated in several test calls, performed under varying conditions. Other thresholds may be selected, however, as desired.

On Windows, flow analysis process 248 may not rely on packet capture, but rather on Event Tracing for Windows (ETW) events sent by the kernel. Some of these events are sent whenever an application receives or sends traffic over UDP or TCP, which can be relied on to detect media servers. Testing on event logs generated by a Window machine during a call has shown that it works without changes. Note that in the case of TCP traffic, the ETW event sent by the kernel because of a call to send( ) or recv( ) might not correspond to one TCP segment. However, flow analysis process 248 may get around this issue by dividing the size element of the ETW event (which represents the size of the payload passed to send( ) or recv( ) by the MTU to approximate the number of actual segments that were sent or received. Testing has demonstrated that this approach works as intended.

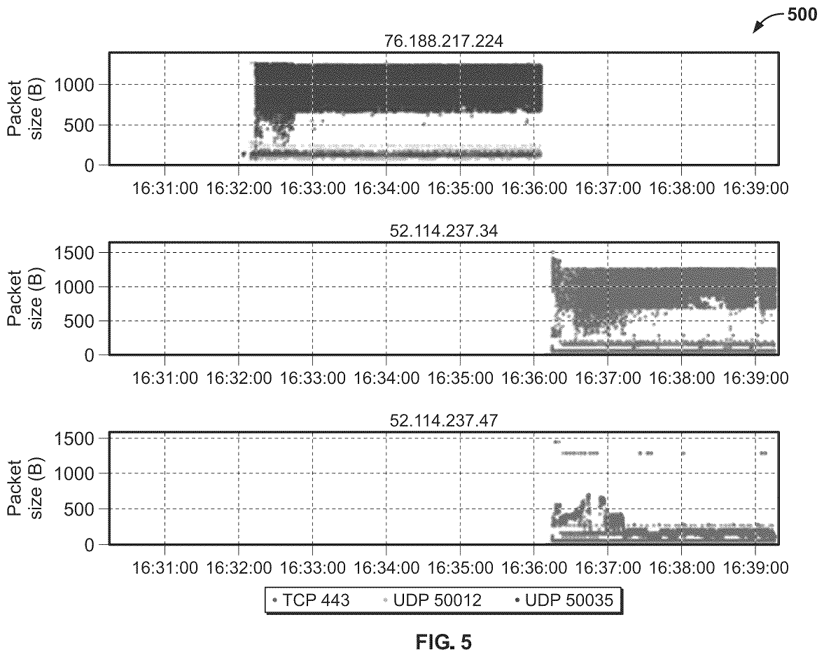

Testing has also revealed that a special case exists when there are only two participants in a call. In such cases, the media traffic might be sent directly from one participant to the other in a peer-to-peer fashion. FIG. 5 illustrates an example plot 500 of media traffic being sent directly from one peer to another during testing. In this particular test, the UDP traffic is blocked mid-call, resulting in the traffic shifting to TCP around the 16:36 mark. The media traffic is initially sent to 76.188.217.224 which belongs to Charter Communications, Inc. (an American ISP), not Microsoft. In addition, the traffic is sent to an ephemeral port instead of one of the ports documented by Microsoft. With the techniques herein, flow analysis process 248 can correctly detect media flows even in peer-to-peer.

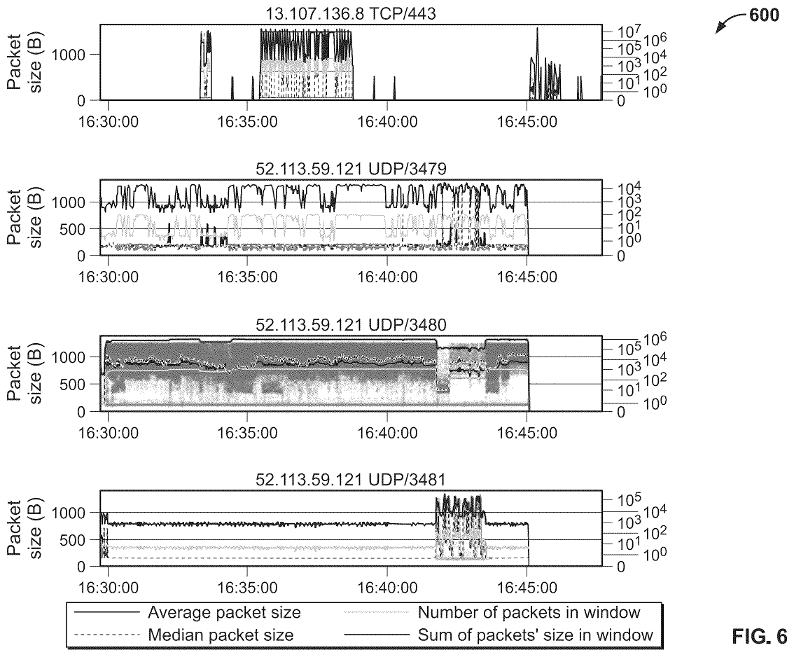

Another special case also exists when one of the participants of a call uploads a file during the call. In such cases, flow analysis process 248 may detect this as a media flow. FIG. 6 illustrates an example plot 600 of such a scenario. More specifically, plot 600 shows the outbound traffic of the user that uploads the file (the plot only includes IP addresses responsible for both the file transfer and the media traffic for the sake of readability). The file transfer happens on 13.107.136.8 on TCP/443; the other flows respectively represent audio, video, and screen share traffic.

During the call, the participant uploaded three files, including a large one (˜750 MB) around 16:35:30. All file transfers happen over TCP/443, and given the average packet size and frequency, the classifier detects file transfer flows as media traffic. This might be desirable behavior: if a file transfer fails to complete, an administrator might want to know why, and automated session testing (AST) might help answer that question.

If it is not possible to use UDP, the videoconferencing applications will fall back to using TCP for media traffic. As noted previously, FIG. 5 shows the traffic during a test call on Microsoft Teams during which all UDP traffic was blocked (around the 16:36 mark). When blocked, the media flows switched to another IP on TCP/443. In such cases, flow analysis process 248 may identify both flows (before and after blocking UDP) as media flow. This highlights again the fact that one cannot simply restrict media flow detection to UDP flow and, similarly, that one cannot consider all high frequency flows happening on TCP/443 to be file transfer flows.

The Microsoft Teams API returns metrics per stream in a call. Streams are logical separations of data across network flows and are identified with an IP address and port number, as well as a label (e.g., main-video1). The IP addresses are often truncated by replacing the final octet with “x” (e.g., 52.113.167.x), presumably for privacy reasons. Accordingly, this data was used to validate the techniques herein. In a test call, the streams labeled as audio/video/application sharing (screen sharing) were all correctly detected as media using the techniques herein. The techniques herein also identified several other flows as media which correspond to file transfers. These are not included in the Microsoft Teams API and are expected.

According to various implementations, flow analysis process 248 may also classify the media in the flows. To do so, flow analysis process 248 may apply one or more thresholds to the various flow metrics that it collects. For instance, flow analysis process 248 may assess the first two minutes of each flow, or from any other initial collection window, to classify those flows.

Using the initial observation window, flow analysis process 248 may compute any or all of the following metrics for a flow:
The average packet size
The throughput
The average interframe time
Etc.

In turn, flow analysis process 248 may then apply various thresholds to these metrics, to distinguish between audio and within the flow. For instance, the following thresholds have proven effective:
If the average packet size is below 250 bytes, the flow comprises audio traffic.
If the average packet size is above 250 bytes, the flow comprises video traffic.

The identification of screen sharing data is more complicated and an approach to do so is highlighted in Appendix A.

With respect to computing the interframe time, flow analysis process 248 may rely on the fact that Microsoft Teams (among others) uses forward error correction to transmit frames split into multiple packets, to detect and potentially repair modifications to the packets. To implement this detection, a frame will be split into packets of the same size (or very close sizes) and sent in bursts. Flow analysis process 248 may use this to detect frame boundaries just by inspecting packet sizes.

Flow analysis process 248 may process the packets in order of arrival and, if their size is the same within a 2-byte range, they belong to the same frame. After identifying the frame boundaries, it is trivial to compute the interframe time: flow analysis process 248 may simply subtract the time of arrival of the last packet of a frame to the time of arrival of the first packet of the next frame.

A prototype of the techniques herein was constructed and tested in both a lab setting, as well as a large-scale deployment, to demonstrate the efficacy of the techniques herein. This testing revealed that the techniques herein are capable of detecting media flows relying only on metadata available at the network and transport layers. It also confirms an assumption herein: in real-time video-conferencing applications, video and audio must be encoded and sent as fast as possible, to minimize delay in communication. Therefore, the application will send packets frequently in order to minimize the delay between recording and transmitting video or audio. The alternative would imply buffering and delay, negatively impacting the real-time experience.

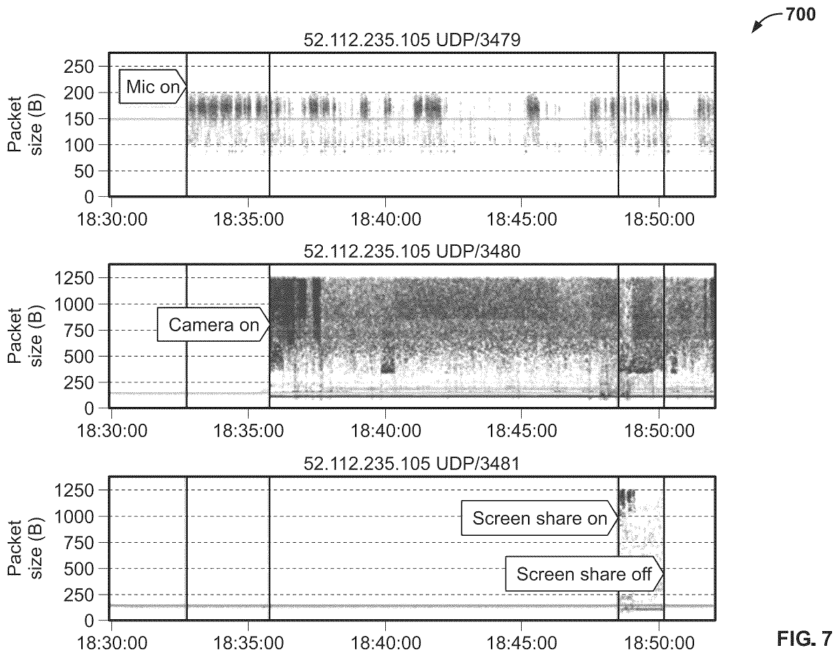

By way of example, FIG. 7 illustrates an example plot 700 of media flow traffic during a Microsoft Teams calls observed during testing. More specifically, plot 700 shows the observed packet sizes over time for the audio (top), video (middle), and screen sharing flows (bottom). The vertical lines show the timing of different user actions including turning on their microphone, turning on their camera, starting screen sharing, and turning off screen sharing.

As noted above, the techniques herein take advantage of this intuition to detect media flows client-side in video-conferencing applications automatically and at-scale. To do so, the techniques herein inspect the traffic for a specific application and proceeds as follows:
(1) given a flow identified by its 5-tuple (e.g., source and destination IP and port, protocol) discretize its traffic into windows of M seconds;
(2) count the number of packets either sent or received during each window;
(3) if a given flow sees more than N packets either sent or received during 10 consecutive windows, classify that flow as a media flow.

During testing, different ranges were explored for the possible values of parameters N and M to find the ones that would minimize the false positive and false negative rates, especially in the case of degradation of the network conditions during a call. When the parameters are too low (for instance, windows of 1 second, or 5 consecutive windows), it was found that the number of false positives (i.e., non-media flows flagged as media) increased significantly. Such false positives included control traffic (e.g., RTCP traffic), or long requests (e.g., file transfer in the chat during a video call). Increasing the values of the parameters removed these false positives.

Conversely, testing also revealed that increasing the parameters too high did not help to reduce the false positive rate and automatically increases the detection time of media flows for no benefit. After extensive testing, windows of M=2 seconds and N=10 packets per window were found to produce the optimal results, although other parameter values could also be used within the scope of the teachings herein.

This approach to media flow detection has the advantage of requiring no training or labeled dataset is easy to implement and maintain. Indeed, it just needs a 5-tuple to identify the flow to which the packet belongs and a timestamp per packet, which makes it suitable for deployment at scale. It does not rely on any protocol specific feature, and can work regardless of the transport protocol that the application uses making the methodology robust to protocols changes and changes at the application layer (e.g., moving to a different media transport protocol altogether). Moreover, it works in near real-time: only 20 seconds are needed to accurately identify all media flows in a call, which makes it suitable for network monitoring solutions. As detailed below, the efficacy of this approach was also tested extensively in both a lab setting and at scale with real users.

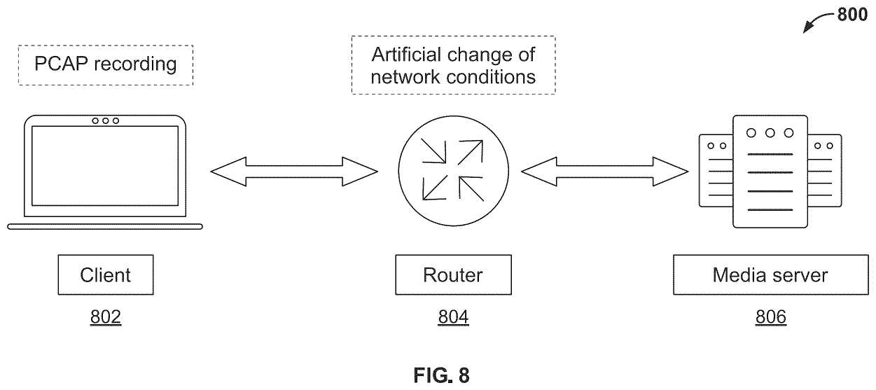

FIG. 8 illustrates an example lab testbed setup 800 that was used to test the techniques herein. As shown, a client 802 interacts with a media server 806 via a network. Packet capture (PCAP) recordings were performed on client 802, to capture traffic information about these interactions. In addition, a router 804 was located between client 802 and media server 806 within the network. In addition to performing its networking functions, router 804 was also configured to artificially change the network conditions, to test the techniques herein under different conditions, such as network outages.

More specifically, router 804 was configured to inject artificial delay, jitter, and loss into the traffic between client 802 and media server 806, to simulate bad network conditions. Router 804 was further configured to block UDP traffic to test whether the techniques herein were still able to detect media flows accurately when the application has to fall back to using TCP.

Testing of the media flow detection approach was done under the following conditions:
(1) normal conditions (no artificial loss, delay, or jitter);
(2) synthetic loss (20% of the packets), delay (500 ms), and jitter (50 ms);
(3) UDP blocked, otherwise normal network conditions;
(4) UDP blocked, with same synthetic loss, delay, and jitter as in (2);

During the tests, client 802 recorded a PCAP file to be able to manually verify that the techniques herein were able to flag all of the media flows without false positives. The PCAP files were recorded on the pktap virtual interface, an Apple-specific interface type that allow one to also capture the name and PID of the process that sent or received each packet. This interface served to filter out all packets that belong to other applications.

Client 802 started its packet capture before launching the application to be tested. If the application under test was WebRTC-based, a Chrome-based browser was used with only one tab opened, to limit the amount of traffic coming from the browser application. Then, client 802 launched the application (or loads the WebRTC application) and initiates a call to a third-party (a team member outside of the client's local network). Each participant joins the call with their camera and microphone off and records the time at which each of these devices is turned on. This allowed for the manual evaluation of the PCAP files from client 802 to identify the actual media flows with media server 806 and verify the results from application of the techniques herein. Screen sharing was also turned on during the test calls and its corresponding on and off times were recorded. After this, the call was terminated by client 802, which then quits the application. Only then did client 802 stop recording the PCAP, to ensure that it captures all the traffic originating from the application being tested.

Table 1 below shows the different applications evaluated during testing and their versions tested (e.g., application or WebRTC):

TABLE 1

| Application Name | Application Version | WebRTC Version |
|---|---|---|
| Microsoft Teams | Yes | Yes |
| Zoom | Yes | No |
| Cisco Webex | Yes | Yes |
| Google Meet | No | Yes |

These applications were chosen based on their popularity. In addition, both application-based software (Zoom) and WebRTC-based solutions (Google Meet) were tested, to ensure that the techniques herein work in both cases. For Cisco Webex and Microsoft Teams, both the stand-alone application and WebRTC-based versions were tested.

The techniques herein were able to detect the full set of media flows for all of the applications in each of the conditions listed in Table 1. After manual verification of the PCAP files recorded on the client and comparison with the timestamps recorded by each participant of the calls, it was verified that the techniques herein were able to accurately identify all video, audio, and screen-sharing flows regardless of network conditions.

One challenge that still remains unsolved is the case of file transfers. Some applications (e.g., Microsoft Teams, Zoom) allow for users to upload files during a call, which are then made available to participants through the chat box. During testing, it was revealed that the techniques herein may flag such transfers as media flows, leading to the only instances of false positives using the techniques herein.

While technically not media flows, these flows might still be considered important to monitor from an end-user perspective when measuring QoE. However, it should also be noted that for some video conferencing applications these flows sometimes do not go to the same IP prefixes as other media flows (for instance, file uploads during Microsoft Teams calls are sometimes directed to a SharePoint IP address instead of a Microsoft media relay). Other applications might implement similar strategies, presenting a potential strategy for filtering out file uploads from media flows, even if application specific.

Not only are the techniques herein able to accurately identify media flows, extensions of the techniques introduced herein are also able to classify them by the type of media they transport. This is an important step for any QoE monitoring solution as some metrics only make sense for certain types of media (for instance, it is meaningless to try to compute the framerate of an audio flow). With access to the RTP headers, determining the media type is relatively trivial as one simply has to use the payload type header field. However, as noted, the increasing use of encryption makes this header information largely unavailable. To overcome this, the techniques herein instead rely on the packet size, which has been shown to be a reliable indicator of the media type.

FIG. 9 illustrates an example 900 of the packet sizes of different types of packets observed during testing: all packets, video packets, audio packets, video RTX packets, and screen share packets. More specifically, FIG. 9 shows the distribution of packet size for a single two-participants call that lasted three minutes during testing, with normal network conditions. It reflects all packets received by a first user, when the second user sent their audio and video during the entire call and shared their screen for one minute. Note that the testing relied on the RTP header of the media flows to get ground-truth data about the type of media being transported. These plots, indicate that the packet size is a reliable indicator for the type of media. Namely, all audio-related packets are below 250 bytes, while video-related packets tend to be above 750 bytes.

It is important to note that the packet size distribution can vary depending on the number of participants in the call. Accordingly, testing was conducted with six participants whereby it was observed that while the packet size in video flows remains the largest of all media types, it can sometimes drop below 750 bytes.

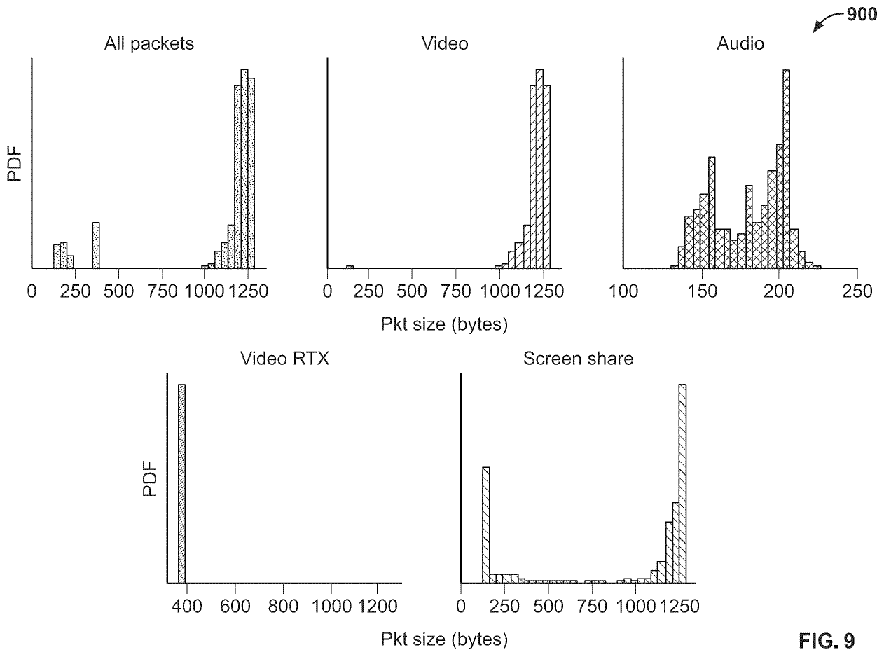

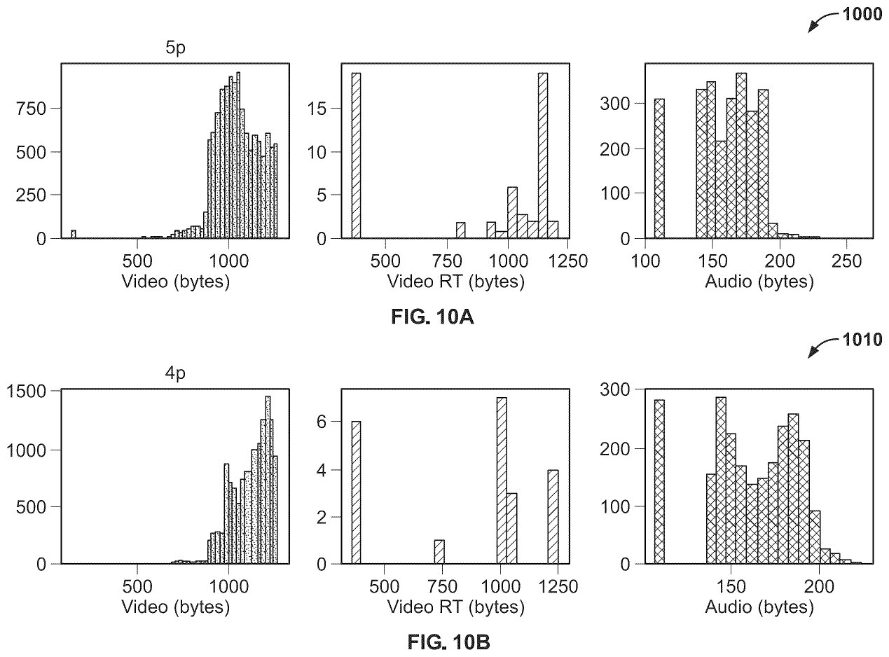

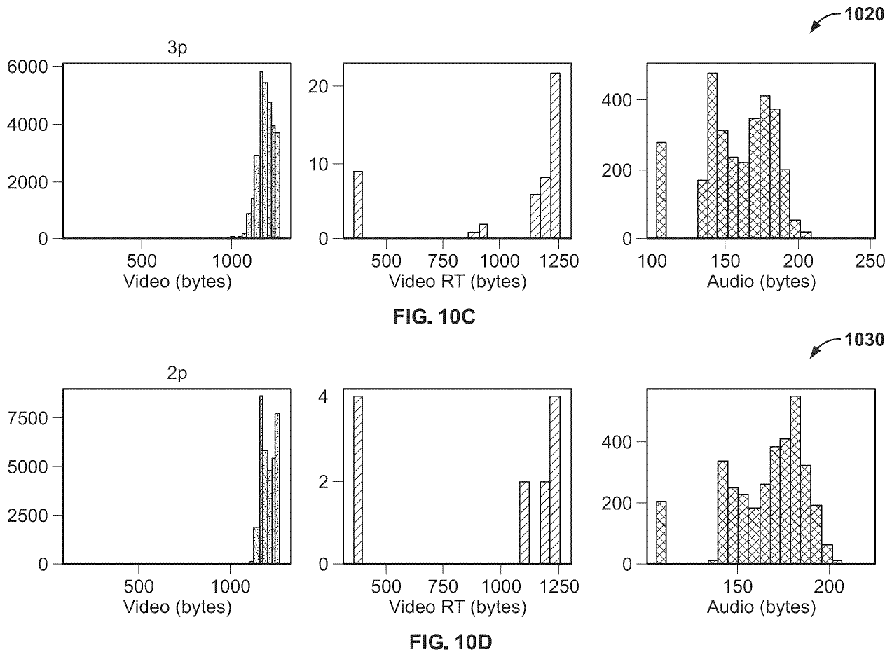

FIGS. 10A-10D illustrate plots of the distribution of packet sizes by media types (e.g., video, video RT, and audio) for calls with different numbers of participants. More specifically, FIG. 10A shows the observed packet size distributions 1000 for five participants, FIG. 10B shows the observed packet size distributions 1010 for four participants, FIG. 10C shows the observed packet size distribution 1020 for three participants, and FIG. 10D shows the observed packet size distribution 1030 for two participants.

From these findings, a lower bound of 250 bytes was selected to identify video flows. Of course, in further implementations, other thresholds could also be selected. Video flows may include not only web cam video, but also screen sharing media. The implementation of RTP in Microsoft Teams uses the same payload type for screen share and video, but with a unique synchronization source identifier (SSRC) for each. This allows the application to distinguish between video and screen sharing feeds, such as those shown in FIG. 9.

As can be seen in FIGS. 10A-10D, screen sharing has a wider range of packet sizes including below the 250 bytes limit. This introduces an extra challenge when estimating application layer metrics of calls, as users sharing screen is an expected behavior, which is address further blow.

It can also be seen in FIGS. 10A-10D that there were some packets received around the 350 bytes range. Their headers reveal that all of these packets were marked as retransmission (RTX) of video. Given that there was no network degradation during the test video call, these packets are likely related to the built-in Forward Error Correction (FEC) technique implemented in Microsoft Teams. On calls with higher packet loss, the number of packets marked as retransmission packets increases and their size distribution becomes more similar to normal video packets.

As discussed above, it is also possible to leverage the RTCP reports to collect some application layer metrics that can be used to infer the QoE metrics for the call. This, however, requires access to unencrypted RTP and RTCP packets. According to various implementations, the techniques introduced herein are also able to estimate the QoE in video conferencing software without relying on RTP headers. To do so, the techniques herein consider any or all of the following: an estimation of the video resolution, detection of frame boundaries (and, therefore, the estimated frame rate), and/or detection of the use of screen sharing.

The QoE estimation approach herein was also tested using Microsoft Teams, as it is the most popular application used in professional settings where ensuring the quality of video calls is of the utmost importance. However, the estimation techniques are not limited as such and should perform similarly on other applications with little to no adjustments. This testing, as detailed below, was performed using both UDP and TCP as the transport layer protocol, achieving similar results.

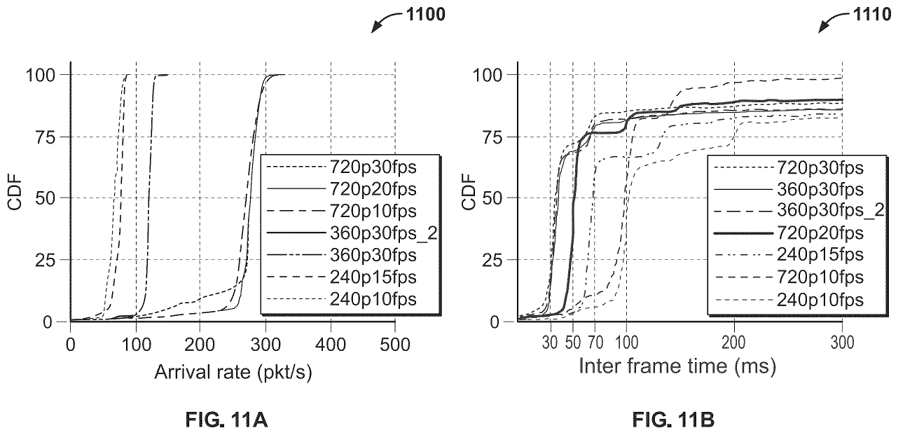

FIGS. 11A-11B illustrate plots of the arrival rates and inter-frame times of test calls. More specifically, for a set of two participant test calls, each with a fixed resolution and frame rate, FIG. 11A illustrates a plot 1100 of the relation between the packet arrival rate and resolution, where calls with the same resolution but different frame rates have similar cumulative distribution functions (CDFs) of arrival rates. FIG. 11B shows the relation of interframe time and the frame rate of the call, whereby calls with the same frame rate, but different resolutions, have similar interval between frames.

To evaluate the efficacy of the QoE estimation approach herein, the following lab setup was used to collect packet captures and ground-truth data: two computers were set up to join the same Microsoft Teams call. On the first one, the FourPeople file from the Xiph.org Video Test Media archive was used, with a 1280×720 resolution and 60 frames per second uncompressed video, played as a loop, to replace the camera feed. OBS Studio was used to control dynamically the frame rate and resolution of the video feed.

The second computer joined the call with the same video settings as the first and PCAPs were generated on both ends of the call. All calls were made using Google Chrome and the WebRTC implementation of Microsoft Teams, as this allows for the collection of ground truth data with temporal granularity using the built-in Chrome internal tools for WebRTC. This tool provides data about resolution, frame rate, loss, among other statistics for all incoming and outgoing media flows. It was also ensured that all calls used a Microsoft Teams media relay server handling the call instead of a peer-to-peer connection. The approach described above was then used to extract the media flows.

In order to passively estimate the video resolution of the call, the direct relationship is explored between the resolution chosen by Microsoft Teams and the packet arrival rate. All calls use the same control video, the parameters are changed with OBS Studio. It should be noted that the packet arrival rate directly correlates with the chosen video resolution: calls at 720p have the arrival rate across the call mostly between 250 and 300 packets per second, with this value dropping as resolution decreases. This shows that these CDFs (e.g., as shown in FIG. 11A) can be used to extract ranges per resolution to create a simple heuristic to infer the video resolution based on packet arrival rate, allowing the possibility to track potential downgrades in real time. Table 2 below summarizes these ranges:

TABLE 2

| Packet Arrival Rate (r) (packets/s) | Resolution |
|---|---|
| r ≥ 250 | 720p |
| 200 ≤ r < 250 | 540p |
| 110 ≤ r ≤ 150 | 360p |
| r < 110 | 240p |

Note that Microsoft Teams currently supports resolutions up to 1080p, but testing showed that a video feed set to this resolution always resulted in the application downgrading the video feed to 720p.

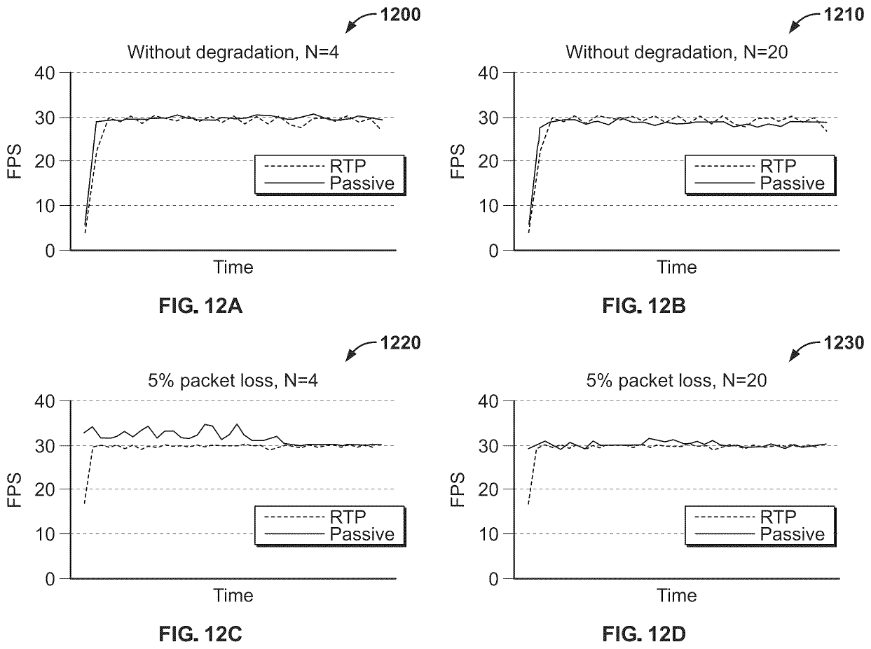

FIGS. 12A-12D illustrate plots comparing frame rate detection approaches: using the RTP header vs, the passive estimation approach herein. More specifically, plot 1200 in FIG. 12A shows the comparison without network degradation and the number of prior packets observed (N) equal to four (N=4). Plot 1210 in FIG. 12B shows the comparison without network degradation but with N=20. Plot 1220 in FIG. 12C shows the comparison with 5% packet loss and N=4. Plot 1230 in FIG. 12D shows the comparison with 5% packet loss and N=20. As can be seen, the passive estimation approach for the frame rate performs quite closely with an RTP header-based approach, even in cases of network degradation, with the quality of the estimation increasing with the number of prior packets observed.

With respect to the frame boundary detection, the techniques herein inspect the timestamp field of the video packets to determine the frame boundaries, according to various implementations. This allows for the analysis as to how the dynamics of packets change as frame rate varies. Indeed, when a frame is split into multiple packets, the RTP timestamp is the same for all these packets and is only incremented for the subsequent frame. As illustrated in FIG. 11B, the frame rate can be passively estimated by measuring the time between subsequent frames and is independent of the video call resolution.

Considering packet P as the last arrived packet, the past P-N packets can be observed to see whether the size S_{P} of P belongs to a range S_{P}±ΔS of the previous N packets that belonged to the last observed frame F_{M-1}. If this is true, the techniques herein can assign P as a packet belonging to frame F_{M-1}. Otherwise, P will be from a new frame F_{M}.

Dialing in both N and ΔS can affect the accuracy of the passive frame boundary estimation. After experimentation, the last N=20 packets were found to offer sufficient performance with respect to the frame estimations under degraded network conditions, although other values could also be selected, as desired.

From FIGS. 12A-12D, it can be seen that whenever packet loss increases, the number of out of order packets also increases, leading to degradation of the passive estimator with smaller N values, which assumes incorrect frame rates above 30 frames per second. This higher value of N improves the estimator in lossy networks, without downgrading frame detection under normal conditions where the passive estimator obtains results similar to the ground truth (obtained by relying on the RTP headers). It was also observed that lower values of ΔS can lead to incorrect estimations, i.e., a frame might be incorrectly split into multiple frames.

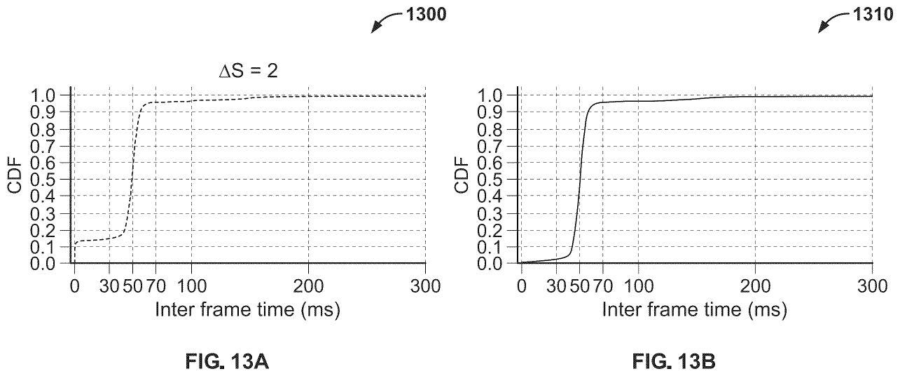

However, FIGS. 13A-13B illustrate plots of the distribution of passively estimated interframe times observed during testing. More specifically, FIG. 13A shows plot 1300 with ΔS=2, while FIG. 13B shows plot ΔS=4. From this, it can be seen that with ΔS=2, over 10% of the identified frames had an interframe time equal to zero. These were in fact packets from the same frame being marked as a new frame, which occurred mostly for frames that had a variation of packet size in the range of 4 bytes. Using ΔS=4 instead solves this issue, although this parameter may be selected as desired.

Indeed, from the results in FIGS. 13A-13B, when ΔS=2, a significant number of frames had their interframe time equal to Oms. When analyzing the difference of packet size across these occurrences, the testing showed that the majority of frames with Oms to the previous frames had a size difference of only 4 bytes. Further inspection showed that all of these packets marking new frames belonged to the previous frame. When increasing this value to ΔS=4, this issue quickly went away: all procurances of interframe time equal to Oms and packet size difference equal to 0 and 4 bytes disappeared, with only remaining incidences being higher size differences. However, these occurrences were sparse and did not affect the quality of the frame boundary detection heuristic. Table 3 below shows the difference in mean packet size across frames for different ΔS values:

TABLE 3

| | |
|---|---|
| ΔS = 2 | ΔS = 4 |

| Packet size diff. | Count | Packet size diff. | Count |
|---|---|---|---|
| 4 | 686 | 76 | 2 |
| 0 | 32 | 16 | 1 |
| 8 | 5 | 360 | 1 |
| 16 | 2 | 184 | 1 |
| 76 | 2 | 8 | 1 |
| 360 | 1 | 480 | 1 |
| 184 | 1 | 80 | 1 |
| 480 | 1 | 12 | 1 |
| 80 | 1 | 28 | 1 |
| 20 | 1 | 256 | 1 |
| 32 | 1 | 372 | 1 |
| 256 | 1 | | |
| 372 | 1 | | |

| | |
|---|---|
| Total = 736 | Total = 13 |

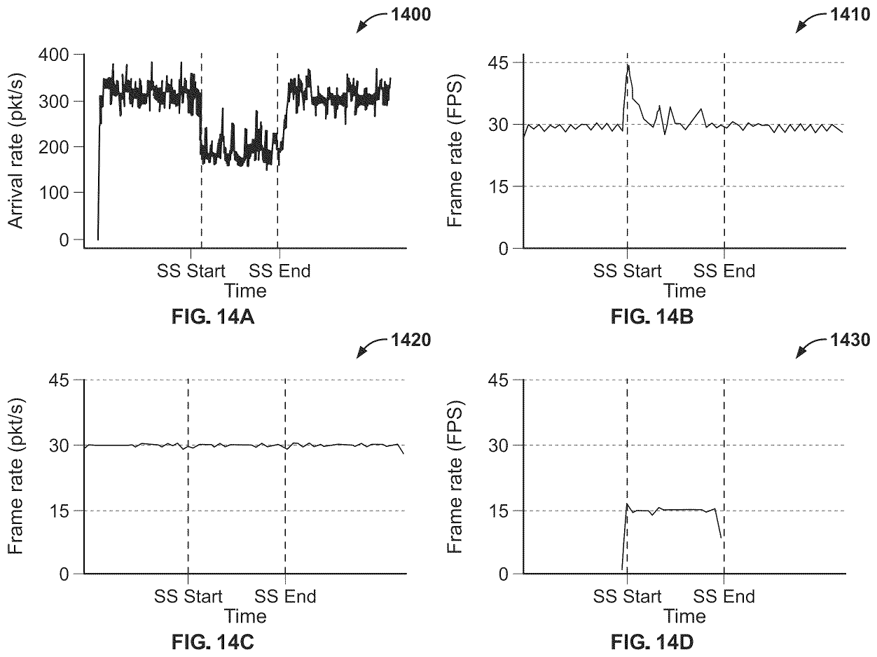

With respect to screen sharing detection, it is common for participants to share their screen during a video conference, and as such, a passive monitoring solution must be able to identify when this occurs. FIGS. 14A-14D illustrate measurement plots for test calls with screen sharing in a two-participant call. More specifically, FIG. 14A shows a plot 1400 of the arrival rate of packets at the receiver. FIG. 14B shows a plot 1410 of the passive estimation of FPS of the call, demonstrating a spike represented by the extra packets related to the new media track. FIG. 14C shows a plot 1420 of the estimation using RTP headers of FPS only for video and FIG. 14D shows a plot 1430 of the estimation using RTP headers of FPS only for screen sharing. From this, it can be seen why there is a spike in 45 frames per second observed on the passive estimation.

Indeed, during a two participant call in which screen sharing was used, it was observed that there was a sudden drop in the packets arrival rate during the time interval when the screen is being shared, as can be seen in FIG. 14A. During this moment, the passive FPS estimator herein was able to detect the quick spike from 30 to 45 frames per second when the screen share starts, shown in FIG. 14B. This spike quickly stabilizes back to 30 frames per second after a few seconds.

When inspecting the RTP header to separate the tracks of video and screen share (observed in FIGS. 14C-14D), it can be noted that the frame rate of the video track is stable at 30 frames per second throughout the entire call duration, with the screen share portion having a stable 15 frames per second during its span. This explains the spike of 45 frames per second of the passive estimator in FIG. 14B.

It is important to note that Microsoft Teams has a frame rate limit of 30 frames per second per participant. Therefore, the drop in the arrival rate, together with the spike in the FPS estimator, can be leveraged to create a heuristic that can determine when a screen share event happens (marked by the drop in the packet arrival rate and abnormal spike in frames per second), as well as when it ends (marked by the normalization of the packet arrival rate).

Using the above estimations, the techniques herein are then able to estimate the QoE of the media flows, in accordance with various implementations herein. By observing the time series of packet arrival rate (in packets per second), it was noted that there is a direct correlation between this metric and the video resolution used by Microsoft Teams. As previously mentioned above, the video resolution can be passively estimated by a simple heuristic matching arrival rate intervals (see, in particular, Table 2 which gives the thresholds to estimate the resolution given the packet arrival rate).

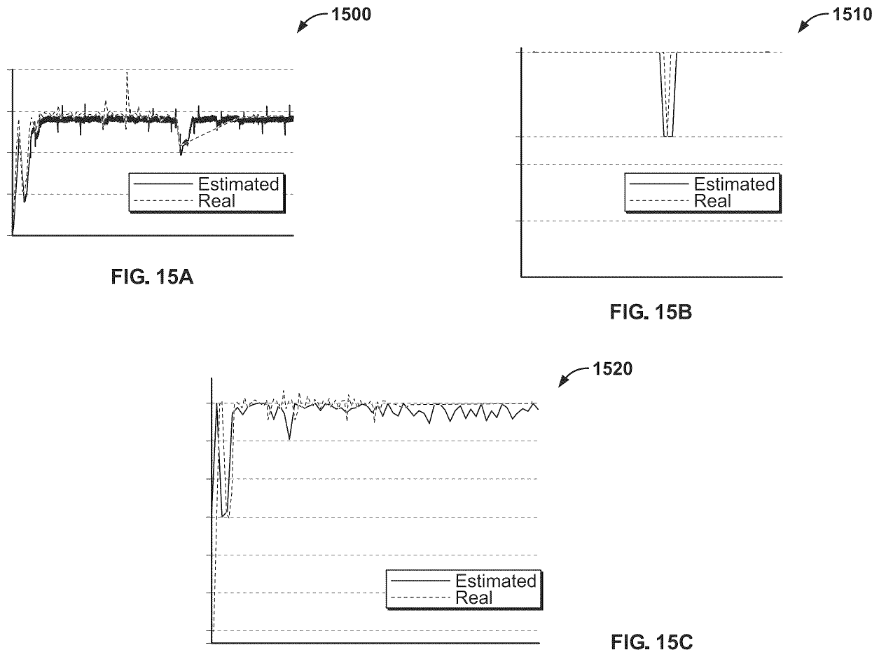

FIGS. 15A-15C illustrate plots demonstrating the passive estimation of the frame rate. Here, FIG. 15A shows a plot 1500 of the estimated vs. real packet arrival rate. FIG. 15B shows a plot 1510 of the estimated vs. real resolution. FIG. 15C shows a plot 1520 of the estimated vs. real frame rate, using the frame boundaries to determine the frame arrival rate.

Now, consider FIG. 15A which shows the packet arrival rate during a short two participant call. This call has at first a slow start followed by a minute of stability, a small drop in the arrival rate which was quickly recovered until the end of the call. Passively tracking these variations in arrival rate is a straightforward task of counting the number of packets identified for Microsoft Teams flows over a time window (e.g., two seconds) and, in the case of FIG. 15A, filtering all packets above 250 bytes to analyze only packets transporting video media. Using the thresholds defined in Table 2, the heuristic is able to track in real time the resolution of this call.

As shown in FIG. 15B, this call started at 720p and the drop in the packets arrival rate resulted in Microsoft Teams briefly down-scaling the resolution to 540p. Since the above techniques are able to passively detect frame boundaries with accuracy, this also allows for the computation of the frame rate. To do so, the techniques herein count the number of frames over a temporal window W (chosen as two seconds for all experiments) and calculate the frame rate as:

$$\frac{1}{W} {\sum }_{m = 1}^{M} {F}_{m}$$

with M representing all identified frames over the temporal window W.

FIG. 15C shows the frame rate estimator in action. As can be seen, it is capable of passively estimating the frame rate of a call, even the stutters in frames during the slow start and showing the continuous thirty frames per second achieved during the remainder of the call.

The frame boundary detection approach herein may rely on either or both of the following parameters: N (number of previous packets to inspect) and ΔS (acceptable difference in size for two consecutive packets). These parameters were adjusted during testing, to account for situations where packet loss increased. First, an artificial 5% packet loss was introduced (e.g., as shown in FIGS. 12C-12D). Smaller values of N (e.g., N=4 as in FIGS. 12A and 12C), an overestimation of frames resulted, going above the Microsoft Teams limit of thirty frames per second. This is due to the increase of out-or-order packets: as packets get lost during their transmission, retransmissions increase; these retransmitted packets from previous frames arrive with an interval beyond N=4, therefore being counted as packets of a newly received frame by the passive estimator.

Experimentation has shown that increasing to N=20 fixed this issue as most retransmitted packets of previous frames arrived within this interval, without degrading the estimation under normal conditions. During internal testing, the techniques herein were able to maintain good estimations up to 10% packet loss, with higher packet losses degrading the passive estimators. Jitter and delay up to 100 ms were also observed to have no visible effect on the estimators.

Finally, the techniques herein also introduce an approach to estimate network degrading conditions without having access to RTP headers. Such degradations include packet jitter, frame jitter, and packet loss.

Packet jitter is relatively straightforward to compute by using the time of arrival of the packets to calculate the mean deviation of arrival times over a moving window. Considering all K packets that arrived at a specific time window, the array of inter-arrival times can be calculated as Δtₖ=Tₖ₊₁−Tₖ, as well as the mean inter-arrival time

$$μ = \frac{1}{K - 1} {\sum }_{k = 1}^{K - 1} Δ {t}_{k} .$$

For each inter-arrival, the deviation is computed from the mean Dk=abs (Δtₖ−μ). Finally, jitter over the time window will be

$$J ( w ) = \frac{1}{K - 1} {\sum }_{k = 1}^{K - 1} {D}_{k} .$$

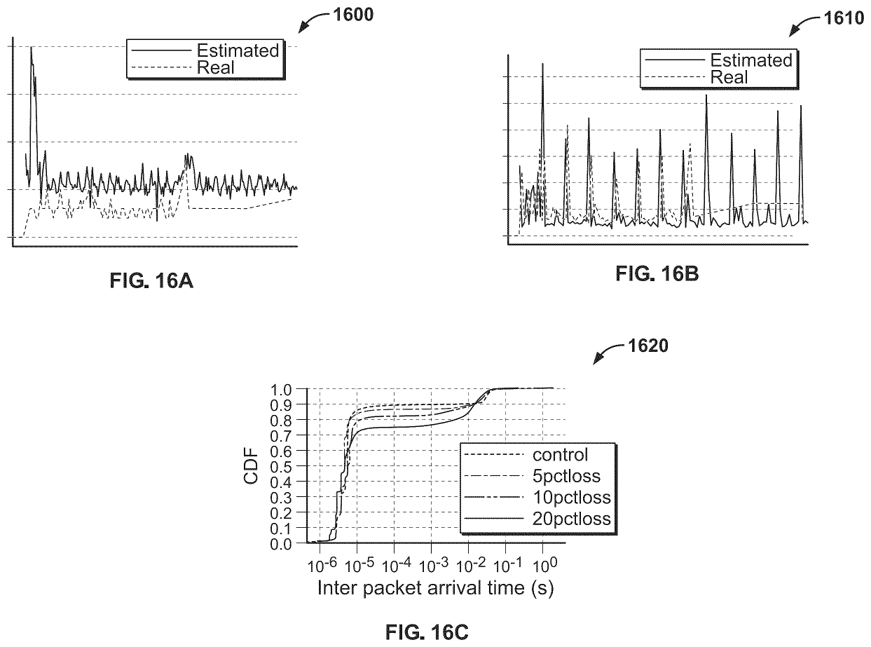

FIGS. 16A-16C illustrate plots demonstrating the passive measurements of network degradation conditions observed during testing of the techniques herein. As shown, FIG. 16A shows a plot 1600 of the real vs. estimated packet jitter, FIG. 16B shows a plot 1610 of the real vs. estimated interframe delay standard deviation, and FIG. 16C shows a plot 1620 of the CDF of the inter packet arrival time for different levels of artificial packet loss. These CDF values can be leveraged to passively estimate the packet loss conditions of the network.

As can be seen in FIG. 16A, the test results are slightly higher than the ground truth obtained, but still reflect variations that may happen in real time. These sudden variations over the norm will indicate worsening network conditions.

The next metric considered is the frame jitter, represented here as the standard deviation of interframe delay. For a time window, considering the difference between the arrival time of the first packet of each frame being Δtk and the mean of frame inter-arrival μ, the standard deviation of the interframe delay can be calculated as

$$σ ( w ) = \sqrt{\frac{1}{K - 1} {\sum }_{k = 1}^{K - 1} {( Δ {t}_{k} - μ )}^{2}} .$$

This measurement is directly dependable of the passive frame boundary detection algorithm and, as can be seen in FIG. 16B, the estimator reflects well the ground truth. Under high loss scenarios, the frame jitter estimation may suffer degradation due to the under performance of the frame boundary estimator. However, it should be noted that under these circumstances the frame rate is also expected to decrease and even lead to video freeze.

According to various implementations, a heuristic to estimate passively packet loss is also introduced herein. Video conferencing applications can leverage the sequence number field of the RTP header to detect packets lost, as this is incremented for every single packet sent from the application. The heuristic-based approach herein involves observing the CDF of inter-packet arrival times, i.e., understanding the variation of intervals between received packets. The intuition is that, in normal network conditions, inter-packet times are within two specific intervals: in the microsecond range, representing the burst of packets sent closely together from a single frame, and in the millisecond range, representing the interval between packets of sequential frames.

This behavior becomes evident for the control curve in FIG. 16C where the bottom 85% of packets are in the range of [1, 10] μs (representing intra-frame packets) while the top 15% are in the range of 10 ms (representing inter-frame packets). The increase of packet loss leads more retransmissions occur, resulting in a reduction of to the % of packets in the range [1, 10] μs to decrease. A quantile function is then applied that can map for a value, such as 10-4s, which quantile of the distribution of inter-packet arrival times of a time window. The result of the quantile function can then be mapped to different packet loss based on empirical tests.

The techniques herein were also validated experimentally at scale with real user calls. To do so, Microsoft Teams calls involving real users were monitored at the media server that end users were assigned to for their calls. End user agents were also used to implement monitoring on the end user devices, as well.

Microsoft Teams was chosen for this validation, as Microsoft makes available a Call Quality Dashboard (CQD). This dashboard includes, among other things, information about the media relays that were used by Microsoft Teams during a given call, as well as the start and end time of each call. This data can be relied on to verify the efficacy of the techniques herein at scale: if a network flow is detected towards a media relay, then this media relay must also appear in the CQD and vice versa, and the times must match. The dataset assessed for this testing included data from 27,200 Microsoft Teams users from 18 different customer organizations. All of these users were running prototypes implementing the media flow detection approach herein. Media flows that saw less than 100 packets for the whole duration of the call, as reported by Microsoft CQD, were also excluded. Such flows might correspond to short file uploads or very short-lived media flows (e.g., a user shutting off their webcam or microphone as soon as they enter a call) which would not be detected by the techniques herein.

Finally, the CQD sometimes does not report full IP addresses but instead masks the last byte (e.g., 52.113.158.x). This happens in 19,269 calls which were also excluded from consideration. In those cases, it is impossible to match the CQD data with the test results, which would end up artificially increasing the number of false positives (i.e., IP addresses detected by us but not reported by the CQD). After filtering, there were a total of 124,278 calls in the dataset.

To assess the efficacy of the techniques herein, the media flows reported by Microsoft and the ones flagged by the techniques herein were compared. For these calls, the techniques herein achieved a true positive rate of 96%, with an average precision per call of 85% and average recall of 96%. It was observed that the average precision is lowered by IPs that were detect but not reported by the CQD. Such IPs could have been detected because of file transfers during calls. Accordingly, the techniques herein were also found to be suitable for large scale, real-world scenarios.

All passive QoE estimation tests done until now were done on calls with two participants. As the number of participant increases, Microsoft Teams presents new behaviors that add complications to the estimations. For example, every new participant that joins a video conference will have their video feed assigned to a new track (differentiated using the SSRC field of the RTP header). However, no matter the number of participants, the tests showed that there will always be a single audio track, with the dominant speaker chosen by the mixer.

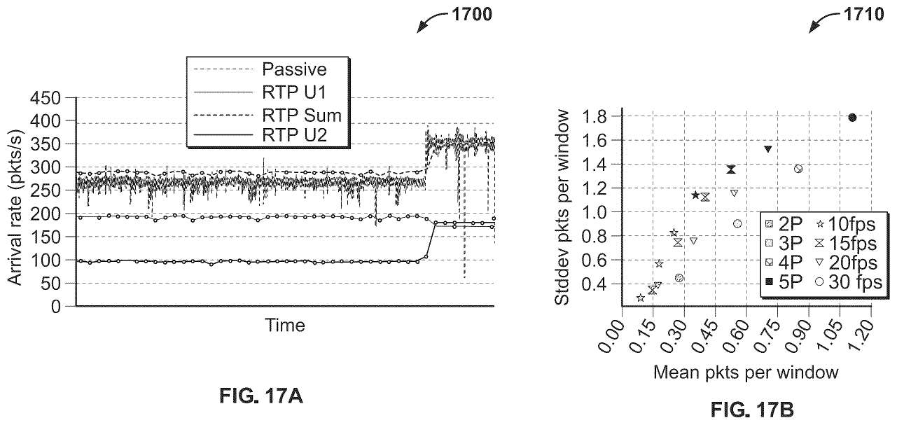

Overall, with every new participant, a new video track is added and, therefore, the number of packets received increases. This introduces a significant challenge for passively estimating QoE, as resolution estimation is directly related to packet arrival rate. FIG. 17A presents an example plot 1700 of a three-participant call, where the receiver side observes the packets arriving from two senders, users/user devices U1 and U2. The arrival rate of U1 and U2 are estimated using the SSRC information. However, the passive estimator has no access to the header fields and leads to an incorrect estimation of the packet arrival rate, which matches the sum of both senders' packets. This could lead to an incorrect estimation of all metrics presented so far (e.g., the frame rate is estimated to be 60 frames per second, as both U1 and U2 have their video feed at 30 frames per second).

Therefore, the differentiation of tracks passively in multi-participant call is a one of the biggest limitations of current approaches. Accordingly, further aspects herein relate to the passive estimation of the number of participant calls by leveraging the variance in packet arrival rate over a quantized grid as more participants join a call. Taking into account a time window of video packets arriving (ten seconds in this case), a quantized time grid could be generated with the same duration and a sampling frequency at least double the highest signal frequency present (in order to respect the Nyquist-Shannon sampling theorem). In this case, each signal will correspond to the video feed of a individual participant. As video feeds of MS Teams are limited to 30 Hz, a sampling frequency of 90 Hz was chosen. The number of packets were then counted that arrived at each slot of the quantized grid across the entire time period and calculate both the mean and standard deviation of the count of packets over the slots.

As observed in plot 1710 in FIG. 17B, a direct correlation exists between these statistics, with values increasing as more participants join and frame rate increase. This is an expected result: as the number of participants increase, more packets are sent from each new video feed, leading to more packets seen at each slot of the quantized grid. Similarly, higher frame rates mean new frames are sent more often, leading to each slot seeing an increased number of packets. If analyzing just the mean, some combinations of number of participants and frame rates can be ambiguous, e.g., four participants at ten frames per second each, three participants at fifteen frames per second each, or two participants at thirty frames per second each all have the same mean packet arrival. This can be solved by observing the standard deviation in the number of packets over the quantized grid: a higher number of participants lead to significant jumps on the standard deviation. As can be seen in FIG. 17B, this leads to a decent separation between values of mean and standard deviation across the possible combinations of number of participants and frame rate.

By performing collections at scale, it is possible to map these two values and create a function that is capable to determine the number of participants of a video conference (without analyzing the RTP headers). Still, the ability of differentiating video tracks remains an open problem that limits the application of application-level metrics to calls larger than two participants.

In summary, the techniques herein resolve the monitoring gap with respect to media traffic flows that stems from the encryption of RTP headers. These techniques operate under the assumption that application-layer information is no longer available in today's video conferencing applications, developing solutions for media flow detection, classification, and QoE monitoring for today's most frequently used video conference applications. In addition, the techniques herein are able to work solely on information available at the network and transport layers, such as packet sizes and timings. This makes the methods robust to future changes and next generation protocols like MoQ, as the network and transport layers will always be available to ensure compatibility with existing network equipment.

The result of the techniques herein is a universal approach for media flow detection that works on any video conferencing application, including WebRTC-based applications, and relies only on packet timing information and flow metadata (i.e., a 5-tuple). This also works in near real-time and can be used for monitoring media flows as the call takes place and does not require any pre-existing training dataset. The techniques herein are also able to leverage packet size and timing information to estimate the QoE of the media calls.

Laboratory testing also shows the efficacy of the techniques herein, showing that they are able to detect all media flows with no false positives or false negatives, including in the case of severely degraded network conditions. Further, large-scale testing also shows the efficacy of the techniques herein at scale, with an average precision per call of 85% and an average recall of 96%.

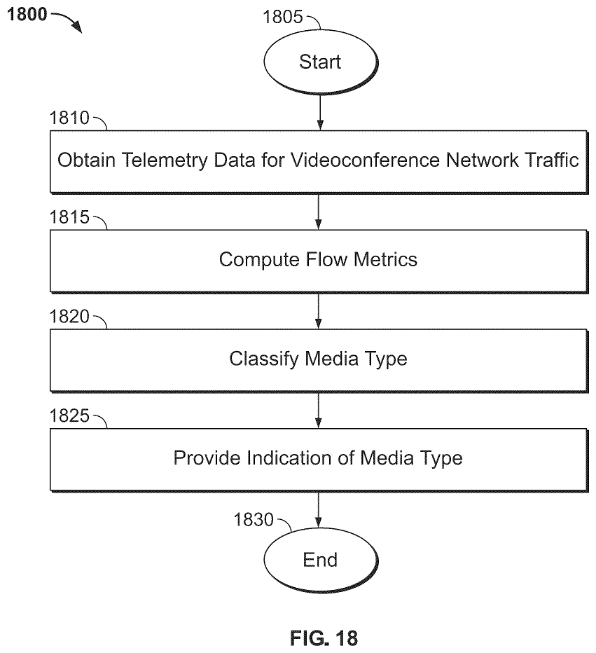

FIG. 18 illustrates an example procedure for the detection and classification of media flows in video conferencing software, in accordance with one or more implementations described herein. For example, a non-generic, specifically configured device (e.g., device 200), may perform procedure 1800 (e.g., a method) by executing stored instructions (e.g., flow analysis process 248). The procedure 1800 may start at step 1805, and continues to step 1810, where, as described in greater detail above, the device (e.g., a controller, server, etc.) may obtain telemetry data for network traffic associated with a videoconference call. In some instances, at least a portion of the telemetry data is captured by an endpoint device participating in the videoconference call.

At step 1815, as detailed above, the device may compute, based on the telemetry data, flow metrics for the network traffic comprising one or more of: a packet size metric or an interframe time metric. In some implementations, the device may also estimate a quality of experience (QoE) metric for the videoconference call based on a packet arrival rate of the network traffic. The device may also provide the QoE metric for display. In one implementation, the device may also estimate a screen resolution or frame rate associated with the videoconference call based on the packet arrival rate of the network traffic. In some implementations, the device may compute the interframe time metric by detecting a frame boundary in the network traffic based on a change in packet size.

At step 1820, the device may classify the network traffic as being of a particular media type based on the flow metrics, as described in greater detail above. In various implementations, the device classifies the particular media type as audio based on the packet size metric being below a threshold value. In further implementations, the device classifies the particular media type as video based on the packet size metric being above a threshold value. In one implementation, the device classifies the particular media type as screen sharing video based on a change in the interframe time metric.

At step 1825, as detailed above, the device may provide an indication that the network traffic is of the particular media type. In some cases, the device may provide the indication for display. In other instances, the device may provide the indication to another device or service for further processing.

Procedure 1800 may then end at step 1830.

It should be noted that while certain steps within procedure 1800 may be optional as described above, the steps shown in FIG. 18 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for the detection and classification of media flows in video conferencing software, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
obtaining, by a device, telemetry data for network traffic associated with a videoconference call;
computing, by the device and based on the telemetry data, flow metrics for the network traffic comprising one or more of: a packet size metric or an interframe time metric;
classifying, by the device, the network traffic as being of a particular media type based on the flow metrics; and
providing, by the device, an indication that the network traffic is of the particular media type.

2. The method as in claim 1, wherein the device classifies the particular media type as audio based on the packet size metric being below a threshold value.

3. The method as in claim 1, wherein the device classifies the particular media type as video based on the packet size metric being above a threshold value.

4. The method as in claim 3, wherein the device classifies the particular media type as screen sharing video based on a change in the interframe time metric.

5. The method as in claim 1, further comprising:
estimating a quality of experience metric for the videoconference call based on a packet arrival rate of the network traffic.

6. The method as in claim 5, further comprising:
estimating a screen resolution or frame rate associated with the videoconference call based on the packet arrival rate of the network traffic.

7. The method as in claim 5, further comprising:
providing the quality of experience metric for display.

8. The method as in claim 1, wherein the device computes the interframe time metric by:
detecting a frame boundary in the network traffic based on a change in packet size.

9. The method as in claim 1, wherein at least a portion of the telemetry data is captured by an endpoint device participating in the videoconference call.

10. The method as in claim 1, wherein the device provides the indication for display.

11. An apparatus, comprising:
one or more network interfaces;
a processor coupled to the one or more network interfaces and configured to execute one or more processes; and
a memory configured to store a process that is executable by the processor, the process when executed configured to:
obtain telemetry data for network traffic associated with a videoconference call;
compute, based on the telemetry data, flow metrics for the network traffic comprising one or more of: a packet size metric or an interframe time metric;
classify the network traffic as being of a particular media type based on the flow metrics; and
provide an indication that the network traffic is of the particular media type.

12. The apparatus as in claim 11, wherein the apparatus classifies the particular media type as audio based on the packet size metric being below a threshold value.

13. The apparatus as in claim 11, wherein the apparatus classifies the particular media type as video based on the packet size metric being above a threshold value.

14. The apparatus as in claim 13, wherein the apparatus classifies the particular media type as screen sharing video based on a change in the interframe time metric.

15. The apparatus as in claim 11, wherein the process when executed is further configured to:
estimate a quality of experience metric for the videoconference call based on a packet arrival rate of the network traffic.

16. The apparatus as in claim 15, wherein the process when executed is further configured to:
estimate a screen resolution or frame rate associated with the videoconference call based on the packet arrival rate of the network traffic.

17. The apparatus as in claim 15, wherein the process when executed is further configured to:
provide the quality of experience metric for display.

18. The apparatus as in claim 11, wherein the apparatus computes the interframe time metric by:
detecting a frame boundary in the network traffic based on a change in packet size.

19. The apparatus as in claim 11, wherein at least a portion of the telemetry data is captured by an endpoint device participating in the videoconference call.

20. A tangible, non-transitory, computer-readable medium storing program instructions that cause a device to execute a process comprising:
obtaining, by the device, telemetry data for network traffic associated with a videoconference call;
computing, by the device and based on the telemetry data, flow metrics for the network traffic comprising one or more of: a packet size metric or an interframe time metric;
classifying, by the device, the network traffic as being of a particular media type based on the flow metrics; and
providing, by the device, an indication that the network traffic is of the particular media type.
